(19) United States
(12) Patent Application Publication
(10) Pub. No.: US 2024/0054905 A1
(43) Pub. Date: Feb. 15, 2024

(54) SYSTEMS AND METHODS FOR EDUCATION UTILIZING AN AUGMENTED REALITY PLATFORM

(71) Applicant: Truist Bank, Charlotte, NC (US)

(72) Inventors: Jahlisa Misenheimer, Concord, NC (US); Micah Ryan Tinklepaugh, Charlotte, NC (US); Kelly Griffin, Matthews, NC (US); Gabriel Sheridan, Iron Station, NC (US)

(73) Assignee: Truist Bank, Charlotte, NC (US)

(21) Appl. No.: 17/819,686

(22) Filed: Aug. 15, 2022

(51) Int. Cl. G09B 5/02; G09B 19/00

(52) U.S. Cl. CPC G09B 5/02; G09B 19/00

(57) ABSTRACT

A system, computer program product, and method for providing educational material via an integrated augmented reality game (AR game) is provided. The AR game is coupled to an external system to retrieve gamer activity to track gamer goals and challenges. The AR game includes a graphical user interface for visualizing gamer-identified goals and their progress, gamer challenges and their progress, gamer profile, gamer activity, educational material, gamer remuneration, and the digital remuneration redemption platform; as well as an interface where the gamer can add, delete, or update goals and challenges in addition to utilize the digital remuneration redemption platform. The AR game will access the gamer location, location images, and other data to provide digital objects in an AR environment to facilitate the AR game.

### FIELD

This invention relates generally to the field of virtual reality and augmented reality, and more particularly embodiments of the invention relate to augmented reality based educational games.

### BACKGROUND

Financial literacy is the knowledge and application of financial skills, including: budgeting, understanding credit, saving, investing, banking, etc. Financial literacy rates in the U.S. population are declining and many people, particularly younger people, struggle with financial literacy. There is also an increase in anxiety around financial decisions; an estimated 77% of the United States adult population experience anxiety related to money, and an estimated 58% feel that their finances control their lives. A need exists for improving the financial literacy in the U.S. and world populations.

Alternatively, roughly half of the United States population identifies as a digital gamer, and there are approximately 177.7 million monthly gamers. Many of digital games utilize virtual reality (VR), or augments reality (AR), systems provide a simulated experience for gamers often using a VR headset or other digital equipment.

### BRIEF SUMMARY

Embodiments of the present invention address the above needs and/or achieve other advantages by providing apparatuses and methods that utilize augmented reality technology to provide education and enhance financial literacy.

In one aspect, a system for providing educational material via an integrated augmented reality game is disclosed. The system comprising at least one processor, a communication interface communicatively coupled to the at least one processor, and a memory device storing executable code that, when executed, causes the at least one processor to: receive, from a gamer on a gamer device, a request to access an augmented reality gaming platform; request identification from the gamer; receive, from an external system, gamer activity; load a gamer profile; record the gamer activity in the game profile; update gamer-identified goal progress and gamer challenge process; provide a digital remuneration redemption platform; provide educational material; present to the gamer a graphical gamer interface; access gamer location; receive image information from the gamer device; and display digital objects within the virtual replica of the gamer location. In some embodiments, the memory device comprises additional executable code, that when executed causes the at least one processor to push a notification to the gamer device based on the gamer location. Additionally, or alternatively, the memory device comprises additional executable code, that when executed causes the at least one processor to push a notification to the gamer based on the gamer-profile.

In another aspect, a computer program product for providing educational material via an integrated augmented reality game is disclosed. The computer program product comprising at least one non-transitory computer readable medium comprising code causing a first apparatus to: receive, from a gamer on a gamer device, a request to access an augmented reality gaming platform; request identification from the gamer; receive, from an external system, gamer activity; load a gamer profile; record the gamer activity in the game profile; update gamer-identified goal progress and gamer challenge process; provide a digital remuneration redemption platform; provide educational material; present to the gamer a graphical gamer interface; access gamer location; receive image information from the gamer device; and display digital objects within the virtual replica of the gamer location. In some embodiments, the computer program product further comprises code causing the first apparatus to push notifications to the gamer device based on the gamer location. Additionally, or alternatively, the computer program product may further comprise code causing the first apparatus to push notifications to the gamer device based on the gamer profile.

In another aspect, a method for providing educational material via an integrated augmented reality game is disclosed. The method comprising: receiving, from a gamer on a gamer device, a request to access an augmented reality gaming platform; requesting identification from the gamer; receiving, from an external system, gamer activity; loading a gamer profile; recording the gamer activity in the game profile; updating gamer-identified goal progress and gamer challenge process; providing a digital remuneration redemption platform; providing educational material; presenting to the gamer a graphical gamer interface; accessing gamer location; receiving image information from the gamer device; and displaying digital objects within the virtual replica of the gamer location. In some embodiments, the method further comprises pushing notifications to the gamer device based on the gamer location. Additionally, or alternatively, the method further comprises pushing notifications to the gamer device based on the gamer profile.

In some embodiments, the graphical use interface includes a visualization of: gamer-identified goals and goal progress, the gamer profile, the gamer challenges and challenge process, gamer activity, educational material, gamer remuneration, and the digital remuneration redemption platform. Additionally, or alternatively, the graphical gamer interface provides an interface for gamer input where the gamer can add, delete, or update gamer-identified goals, update or accept new gamer challenges, and utilize the digital remuneration redemption platform to redeem digital remuneration for virtual content.

In some embodiments, the gamer profile comprises gamer-identified goals, gamer challenges, and gamer remuneration. Additionally, in some embodiments, the gamer profile may further comprise a gamer avatar.

In some embodiments, the gamer remuneration is recorded on a distributed ledger.

In some embodiments, the educational material is in the form of a video. Additionally, or alternatively, the educational material is an article. In some embodiments the educational material is a sound-clip. Additionally, or alternatively the educational material is a puzzle.

In some embodiments, the gamer device is a virtual reality headset. In some embodiments, the gamer device is a smart phone. Additionally, or alternatively, the gamer device is a virtual reality ocular system. In some embodiments, the gamer device is a combination of a smart phone and a virtual reality headset. In some embodiments, the gamer device is a combination of a smart phone and a virtual reality ocular system. In some embodiments, the gamer device is a combination of a virtual reality ocular system and a virtual reality headset.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an enterprise system and environment thereof for providing educational material via an integrated virtual reality game, in accordance with at least one embodiment.

FIG. 2A illustrates equipment items, according to at least one embodiment, used in a virtual reality (VR) session.

FIG. 2B shows a gamer view of a simulated environment in a VR session via a helmet or visor.

FIG. 3A illustrates an AR session in which a gamer views a background scene through an AR equipped mobile device.

FIG. 3B shows the AR image 306 on the mobile device 106.

FIG. 4 shows an exemplary graphical user interface within the augmented reality game in accordance with at least one embodiment.

FIG. 5 shows a process flow for the augmented reality platform in accordance with at least one embodiment.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

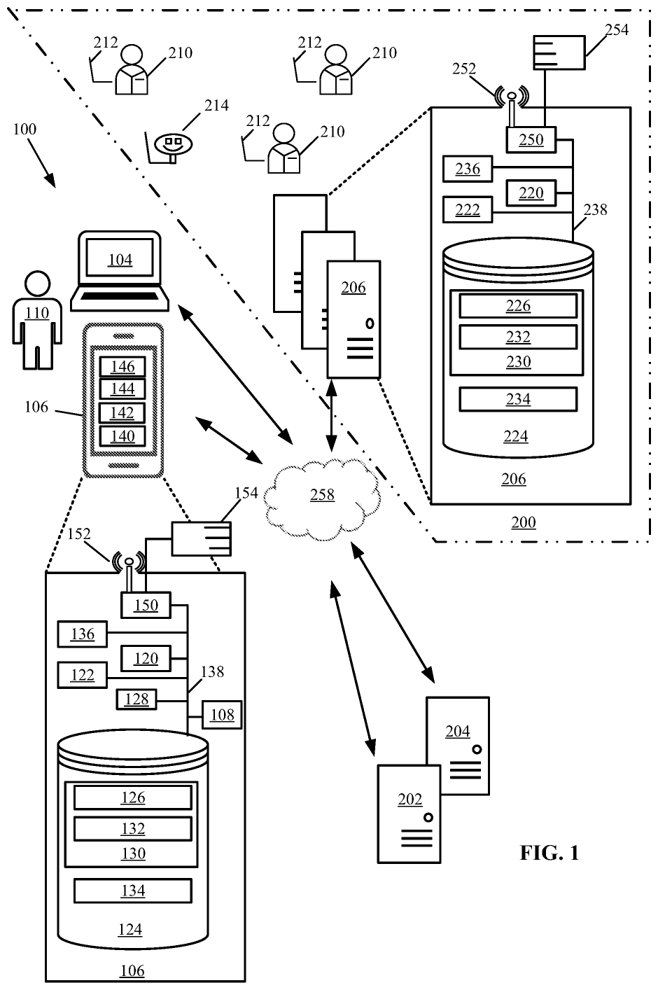

FIG. 1 illustrates a system 100 and environment thereof, according to at least one embodiment, by which a gamer 110 benefits through use of services and products of an enterprise system 200. The gamer 110 accesses services and products by use of one or more gamer devices, illustrated in separate examples as a computing device 104 and a mobile device 106, which may be, as non-limiting examples, a smart phone, a virtual reality headset, a virtual reality ocular device, other virtual reality devices, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other gamer-accessible computing device.

Furthermore, the gamer device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The gamer 110 can be an individual, a group, or any entity in possession of or having access to the gamer device, referring to either or both of the mobile device 104 and computing device 106, which may be personal or public items. Although the gamer 110 may be singly represented in some drawings, at least in some embodiments according to these descriptions the gamer 110 is one of many such that a market or community of gamers, consumers, customers, business entities, government entities, clubs, and groups of any size are all within the scope of these descriptions.

The gamer device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, gamer files such as those for pictures, audio and/or video recordings, files downloaded or received from other devices, and other data items preferred by the gamer or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical gamer interface (GUI) on the display 140 that allows the gamer 110 to communicate with the mobile device 106, and, for example a mobile banking system, and/or other devices or systems. In one embodiment, when the gamer 110 decides to enroll in a mobile banking program, the gamer 110 downloads or otherwise obtains the mobile banking system client application from a mobile banking system, for example enterprise system 200, or from a distinct application server. In other embodiments, the gamer 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the gamer device and the applications and devices that facilitate functions of the gamer device, or are in communication with the gamer device, to implement the functions described herein and others not expressly described. For example, the storage device may include such data as gamer authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and gamer inputs and outputs such as receiving commands from and providing displays to the gamer.

The mobile device 106, as illustrated, includes an input and output system 136, referring to, including, or operatively coupled with, gamer input devices and gamer output devices, which are operatively coupled to the processing device 120. The gamer output devices include a display 140 (e.g., a liquid crystal display or the like), which can be, as a non-limiting example, a touch screen of the mobile device 106, which serves both as an output device, by providing graphical and text indicia and presentations for viewing by one or more gamer 110, and as an input device, by providing virtual buttons, selectable options, a virtual keyboard, and other indicia that, when touched, control the mobile device 106 by gamer action. The gamer output devices include a speaker 144 or other audio device. The gamer input devices, which allow the mobile device 106 to receive data and actions such as button manipulations and touches from a gamer such as the gamer 110, may include any of a number of devices allowing the mobile device 106 to receive data from a gamer, such as a keypad, keyboard, touch-screen, touchpad, microphone 142, mouse, joystick, other pointer device, button, soft key, and/or other input device(s). The gamer interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other gamer input devices and output devices for use by or communication with the gamer 110 in accessing, using, and controlling, in whole or in part, the gamer device, referring to either or both of the computing device 104 and a mobile device 106. Inputs by one or more gamer 110 can thus be made via voice, text or graphical indicia selections. For example, such inputs in some examples correspond to gamer-side actions and communications seeking services and products of the enterprise system 200, and at least some outputs in such examples correspond to data representing enterprise-side actions and communications in two-way communications between a gamer 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the gamer device. As discussed herein, the system intraconnect 138 may operatively couple various components with one another, or in other words, electrically connects those components, either directly or indirectly—by way of intermediate component(s)—with one another.

The gamer device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more gamers 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to gamer accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to gamers 110, advisors, managers, sales team members, and referral agents ready to route gamer requests and communications to preferred or particular other agents, human or virtual.

Human agents 210 may utilize agent devices 212 to serve gamers in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the gamer device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other gamer input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, gamer-side actions and communications in two-way communications between a gamer 110 and an enterprise-side human agent 210.

From a gamer perspective experience, an interaction in some examples within the scope of these descriptions begins with direct or first access to one or more human agents 210 in person, by phone, or online for example via a chat session or website function or feature. In other examples, a gamer is first assisted by a virtual agent 214 of the enterprise system 200, which may satisfy gamer requests or prompts by voice, text, or online functions, and may refer gamers to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for gamer accounts, gamer profiles, account balances, and transaction histories, files downloaded or received from other devices, and other data items preferred by the gamer or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the gamer device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The gamer devices, referring to either or both of the mobile device 104 and computing device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, gamers, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving gamers 110. In another example, the external systems 202 and 204 represent payment clearinghouse or payment rail systems for processing payment transactions, and in another example, the external systems 202 and 204 represent third party systems such as merchant systems configured to interact with the gamer device 106 during transactions and also configured to interact with the enterprise system 200 in back-end transactions clearing processes.

In certain embodiments, one or more of the systems such as the gamer device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed

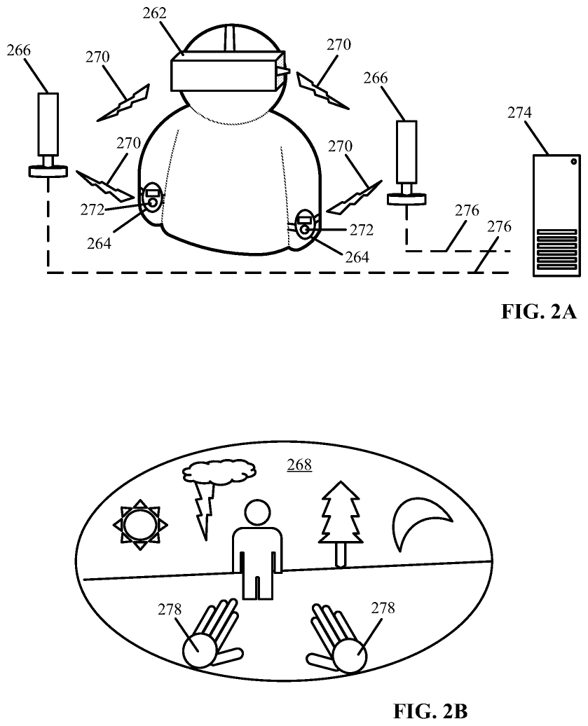

The above-described systems and computing devices, in some embodiments, are used in whole or in part to implement virtual reality (VR) and/or augmented reality (AR) functioning. Virtual reality refers to a computer-generated simulation of a three-dimensional image or environment that can be interacted with in a seemingly real or physical way by a person using special electronic equipment, such as a visor or helmet with an internal screen, and gloves, hand-held controller, and/or other effects fitted with sensors. A VR experience is typically immersive, offering the gamer a typically entirely artificial computer-generated environment. As vision of the real world around the gamer is occluded by a VR headset, such as a visor or a helmet, a VR session typically occurs indoors and/or in a safe controlled environment for the safety of the gamer. VR equipment items are typically interactive devices represented in FIG. 2A as a visor or helmet 262. In some instances, as illustrated in FIG. 2A, hand-held or mounted controllers 264, and sensors 266 also enable the VR experience. Connections 270 in FIG. 2A represent interconnectivity among the visor or helmet 262, controllers 264, and sensors 266. The connections 270 may be wireless as represented in FIG. 2A and/or may include wired connections as well. Although FIG. 2A illustrates the use of extensive VR equipment, the VR experience disclosed herein may be achieved with little to no VR equipment. In some embodiments, the VR experience is experienced entirely through a gamer's smart phone.

VR applications immerse the gamer in a computer-generated environment (FIG. 2B) that simulates reality through the use of the interactive devices. The gamer device may provide the gamer with a stereoscopic view 268 of animated images in the simulated environment. The illusion of “being there” (telepresence) may be effected by motion sensors that pick up the gamer's movements to enable adjustment of the view provided the gamer in real time. Thus, a gamer can tour a simulated suite of rooms, experiencing changing viewpoints and perspectives that are convincingly related to their own head turnings and steps. The hand-held or mounted controllers 264 typically include buttons and/or triggers 272 by which gamer actions are relayed to the computing device or system 274 to effect gamer control of their simulated character and/or to implement gamer actions with the simulated environment. The hand-held or mounted controllers 264 can be equipped with force-feedback devices that provide the sensation of touch. The hand-held or mounted controllers 264 can be ergonomically formed for comfort and secure grasp in use.

The gamer can, for example, pick up and manipulate objects that they see in the virtual environment. Visual confirmation of hand-held items and their manipulation can be presented to the gamer in the simulated environment via a simulated view of the hands, which may appear as character hands 278, such as robot, alien, athlete, soldier or other character hands. Connections 276 in FIG. 2A represented interconnectivity between the sensors and/or other interactive devices with a computing device or system 274 by which calculations and other operation are conducted to dynamically produce the changing simulated environment in which gamer actions such as hand movements, head movements (looking up, down, left, and right), and gamer-positioning within a safe environment are typically all represented in the simulated environment. The connections 276 may be wired as represented in FIG. 2A and/or may be or include wireless connections as well. The computing device or system 274 may represent any of the gamer computing device 104, the mobile device 106, the computing system 206 of the enterprise system 200, and/or the external systems 202 and 204 (FIG. 1). A visual VR session is illustrated in FIG. 2B. Audio information may be provided as well, for example via speakers within or mounted on the visor or helmet 262 or other nearby equipment items. A VR session can be used for gaming, viewing information, navigation, and many other uses.

Augmented reality (AR) refers to the integration of digital information with the gamer's environment in real time. Unlike virtual reality (VR), which creates a totally artificial environment, AR gamers experience a real-world environment with computer-generated perceptual information visually combined or overlaid on real world images. The computer-generated simulation of a three-dimensional image or environment can be interacted with in a seemingly real or physical way, typically using a mobile phone such as the gamer mobile device 106. Because an AR experience does not typically greatly occlude the gamer's view of their real environment, AR use is potentially more mobile and safer to use outdoors and/or in less controlled environments than VR. However, electronic equipment, such as the visor or helmet 262 (FIG. 2A) and hand-held or mounted controllers 264 may be used as well. As used herein, a VR headset is defined as any virtual reality enabled helmet, visor, and/or goggles and may be used with or without hand-held or mounted controllers. As used herein, a VR ocular device is defined as any virtual reality enabled glasses or lenses that can display AR objects without completely obstructing the gamers view.

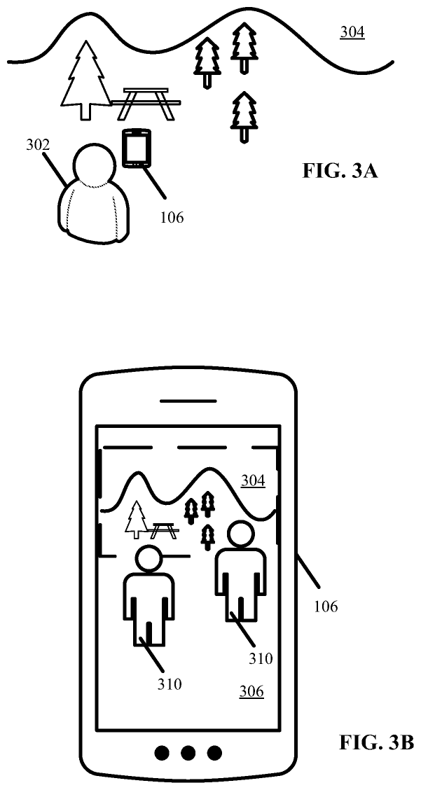

FIG. 3A illustrates an AR session in which a gamer 302 views a background scene 304 through an AR equipped mobile device 106. FIG. 3B shows the AR image 310 on the mobile device 106. A visual AR session is illustrated. Audio information may be provided as well via speakers of the device 106. The AR image 306 includes characters 310 combined with or overlaid in the background scene 304. Any number of artificial characters and/or objects can be included. An AR session can be used for gaming, viewing information, navigation, and many other uses.

The present invention includes a system for providing educational material via an integrated augmented reality game (AR game). In some instances the AR game includes virtual reality based tasks, challenges, etc. In some instances, the AR game includes augmented reality based tasks, challenges, etc. The system, as described above, includes at least one processor, a communication device communicatively coupled to the at least one processor and a memory device storing executable code that causes the processor to perform various functions to enable to AR game of the present invention. The goal of the AR game is to educate the general population with a goal of increasing financial literacy. Financial literacy is defined as the knowledge and application of various financial skills. These skills include: budgeting, investing, saving, financing, etc.

The AR game, also known as the Challenge Center, is integrated with the gamer's financial accounts, such as savings, checking, investing, etc. In this way, the gamer can identify goals and track the progress of each goal within the AR game.

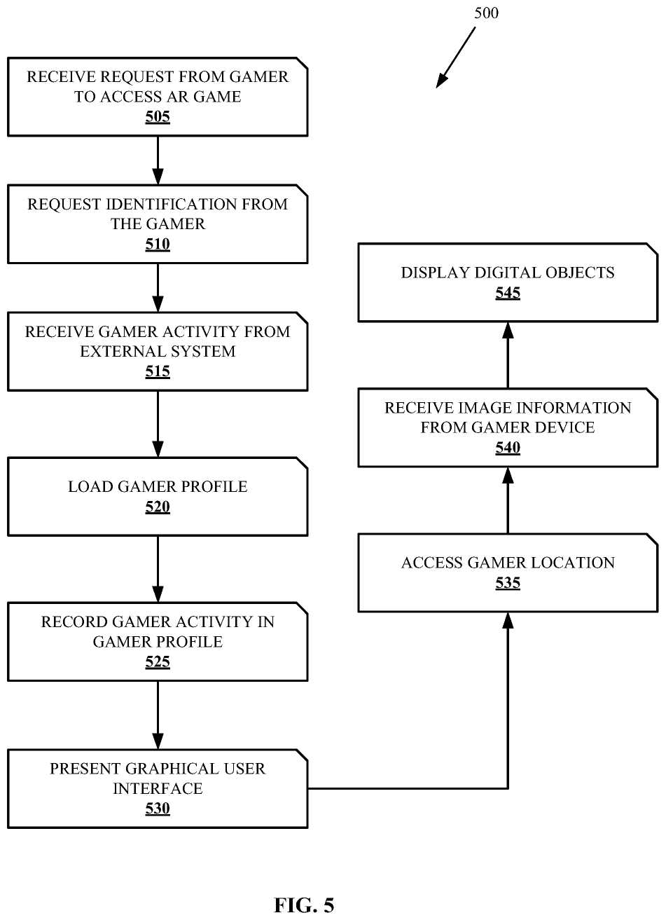

As illustrated in FIG. 5, the system may receive a request from the gamer to access the game 505. In some embodiments, the gamer may access the AR game from their mobile banking app. Additionally, or alternatively, the gamer may access the AR game from a notification. In some embodiments, the gamer may access the AR game from a website. Additionally, or alternatively, the gamer may access the AR game from an AR game dedicated app on the gamer device.

Once the gamer requests access to the game, i.e. opens the app, clicks on a link, etc, the system will prompt the gamer for identification 510. In some embodiments, the identification is a user name and password. Additionally, or alternatively, the identification may be an account number. In some embodiments, the identification may be a personal identification number. The AR game will receive, from an external system, gamer activity 515. The external system may be any system that the gamer has elected to couple to the AR game. In some instances, the external system may be the gamer's banking system. In some instances, the external system may be the gamer's social network. In the instance where the external system is the gamer's banking system, the gamer activity may include the gamer's account(s) ledger. In this way, when the gamer sets goals in the AR game, progress can be recorded in the gamer's profile. The AR game will load the gamer's profile 520 upon log in, or approval of the gamer's identification and record gamer activity 525 from the external system. The system will present the gamer profile and other information to the user via a graphical user interface 530.

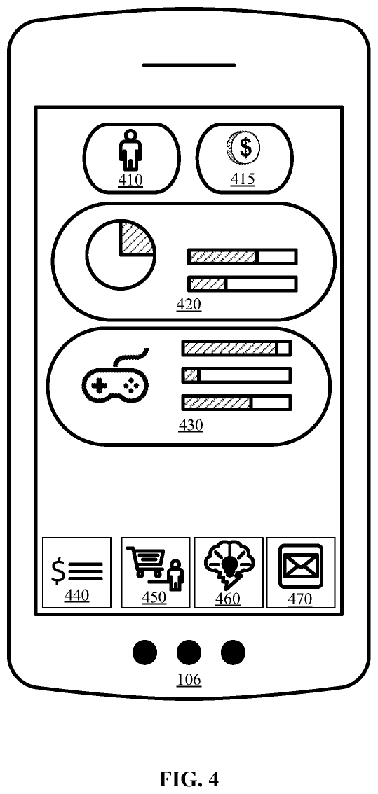

An example graphical user interface 400 within the AR game is illustrated in FIG. 4. The graphical user interface 400 may display a visualization of the user profile 410, the gamer's identified goals and the progress of each goal 420, the gamer's challenges and progress of each challenge 430, the gamer's activity 440, the educational material 460, earned gamer remuneration 415, the digital remuneration redemption platform 450, and notifications 470. Additionally, the graphical user interface will provide an interface where the gamer can add, update, and/or delete gamer-identified goals; accept and/or update gamer challenges; and utilize gamer remuneration in the digital remuneration redemption platform.

The gamer's profile may include the gamer's identified goals, gamer challenges, and gamer remuneration. Gamer-identified goals may include goals such as saving for a particular item, activity, experience, etc; investing a particular amount or percentage; paying down a loan; or any other measureable financial goal. Gamer challenges are designed to challenge the gamer and/or teach the gamer. Examples of gamer challenges include: puzzles, scavenger hunts, tasks, etc. Gainers may receive remuneration for completing gamer challenges, achieving certain milestones, and/or reaching or completing a gamer-identified goals.

Gamer remuneration is received to reward the gamer for completing tasks, challenges, achieving goals, etc. The gamer remuneration may be recorded on a distributed ledger and used as virtual currency in the digital remuneration redemption platform. The gamer remuneration redemption platform is an online marketplace where gamers can use/spend their received gamer remuneration. For example, gamers may redeem remuneration to obtain virtual content. An example of virtual content includes apparel for an in-game avatar. In some embodiments, the remuneration may be redeemed for physical content.

One aspect of the AR game is to provide educational material to the gamer. Educational material may include educational videos, sound-clips, podcasts, articles, etc. Educational material may also include puzzles, games, trivia, etc. The gamer may receive gamer remuneration for reviewing and/or interacting with the educational material provided in the AR game. The educational material may be designed to teach the gamer financial skills such as: saving, budgeting, and investing. The gamer may receive gamer remuneration for completing educational material.

One aspect of the AR game is to provide a VR and/or AR experience. To accomplish this, the system will access the gamer location 535. In some embodiments, the gamer location is determined using the GPS on the gamer device. To provide the VR/AR experience, the system may display a virtual replica of the gamer location. This may be displayed on a VR headset, VR ocular device, or on the screen of a gamer smartphone. The system may further receive image information from the gamer device 540. Based on the images received and the gamer location, the system will display digital objects 545 on the gamer device or gamer devices. These digital objects may be determined based on the gamer profile. For example, if the gamer-identified goal is to save a specific amount of money, the AR game may display in the VR/AR experience places the gamer may shop in order to save money. In another example, the AR game may display incentives for shopping at a partnered entity. Digital objects may also be based on gamer challenges. For example, if a challenge is a scavenger hunt, the objectives in the scavenger hunt may appear as digital objects in the VR/AR experience. The digital objects may be informational. The digital objects may also be configured to be interacted with by the gamer.

The system may also push a notification to the gamer based on gamer location. For example, if the gamer is near a challenge location, the system may push a notification to the gamer device to inform the gamer of the challenge. In another example, if the gamer's location is at a relevant location to one of the gamer-identified goals the system may push notification to the gamer device to remind the gamer of the goal. For instance, if the gamer's goal is budgeting, the system may notify the user of their proposed grocery budget when the gamer is located at a grocery store. The system may push a notification to the gamer based on the gamer-identified goals to remind the gamer of the goals and their progress toward the goal.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

1. A system for improving user experience by providing educational material via an integrated augmented reality game, the system comprising:
at least one processor;
a communication interface communicatively coupled to the at least one processor; and
a memory device storing executable code that, when executed, causes the at least one processor to:
receive, from a user via an augmented reality gaming device, a request to access an augmented reality gaming platform, wherein the augmented reality gaming platform comprises one or more educational augmented reality games;
receive user identification from the user via the augmented reality gaming device;
determine whether the user identification received from the user is authentic;
in response to determining the user identification received from the user is authentic, gather user account data associated with the user, wherein the user account data comprises one or more financial accounts associated with the user;
provide the user access to at least one of the one or more educational augmented reality games;
receive an indication from the user of a goal to complete the at least one of the one or more educational augmented reality games;
create a user gaming profile for the user, wherein the user gaming profile comprises the goal to complete the at least one of the one or more educational augmented reality games;
record one or more interactions between the user and the at least one of the one or more educational augmented reality games;
store the record of the one or more interactions of the user in the user gaming profile for the user;
at least partially based on the stored record of the one or more interactions of the user, determine that the user has achieved the goal to complete the at least one of the one or more educational augmented reality games;
at least partially based on determining that the user has achieved the goal to complete the at least one of the one or more educational augmented reality games, transfer remuneration to the user gaming profile for utilization by the user;
receive a request to transfer at least a portion of the remuneration from the user gaming profile to an external system for utilization of the remuneration by the user;
communicatively connect a channel to the external system, wherein the external system comprises a digital remuneration redemption platform;
transform the portion of the remuneration from the user gaming profile into a format compatible for utilization within the external system; and
transfer the transformed remuneration to the external system.

2. The system for improving user experience by providing educational material via an integrated augmented reality game according to claim 1, wherein digital remuneration redemption platform is an online marketplace.

3. The system for improving user experience by providing educational material via an integrated augmented reality game according to claim 1, wherein the memory device comprises additional executable code, wherein the additional executable code, when executed, causes the at least one processor to: push one or more notifications to the augmented reality gaming device at least partially based on the user gaming profile.

4. The system for improving user experience by providing educational material via an integrated augmented reality game according to claim 1, wherein the user gaming profile further comprises a gamer avatar.

5. The system for improving user experience by providing educational material via an integrated augmented reality game according to claim 1, wherein the remuneration transferred to the user gaming profile is recorded on a distributed ledger.

6. The system for improving user experience by providing educational material via an integrated augmented reality game according to claim 1, wherein the educational material is in the form of a video, an article, a sound-clip, or a puzzle.

7. The system for improving user experience by providing educational material via an integrated augmented reality game according to claim 1, wherein the augmented reality gaming device comprises: a smart phone, a virtual reality headset, a virtual reality ocular system, or a combination thereof.

8. A computer program product for improving user interaction by providing educational material via an integrated augmented reality game, the computer program product comprising at least one non-transitory computer readable medium comprising code causing a first apparatus to:
receive, from a gamer on a gamer device, a request to access an augmented reality gaming platform, wherein the augmented reality gaming platform comprises one or more educational augmented reality games comprising educational material;
request user identification from the gamer via the gamer device;
determine whether the user identification received from the gamer is authentic;
gather gamer profile data associated with the gamer, wherein the gamer profile data comprises gamer activity associated with one or more external systems;
provide the gamer access to the augmented reality gaming platform;
receive an indication from the gamer device of a goal to complete at least one of the one or more educational augmented reality games from the augmented reality gaming platform;
record one or more interactions of the gamer with the least one of the one or more educational augmented reality games;
attach the record of the one or more interactions of the gamer to the gamer profile data;
determine that the gamer has completed the goal;
at least partially based on determining that the gamer has completed the goal, transmit remuneration to the gamer, wherein the transmitted remuneration is attached to the gamer profile data for utilization by the gamer;
receive a request to transfer at least a portion of the remuneration from the gamer to an external system for utilization of the remuneration by the gamer;
communicatively connect a channel to the external system, wherein the external system comprises an online remuneration redemption marketplace;
transform the portion of the remuneration into a format compatible for utilization on the online remuneration redemption marketplace; and
transmit the transformed remuneration to the external system.

9. The computer program product for improving user interaction by providing educational material via an integrated augmented reality game according to claim 8, further comprising code causing the first apparatus to: utilize the transformed remuneration on the online remuneration redemption marketplace to purchase at least one of virtual content and physical content.

10. The computer program product for improving user interaction by providing educational material via an integrated augmented reality game according to claim 8, further comprising code causing the first apparatus to: push one or more notifications to the gamer device, based on the gamer profile data.

11. The computer program product for improving user interaction by providing educational material via an integrated augmented reality game according to claim 8, wherein the gamer profile data further comprises a gamer avatar.

12. The computer program product for improving user interaction by providing educational material via an integrated augmented reality game according to claim 8, wherein the remuneration transmitted to the gamer is recorded on a distributed ledger.

13. The computer program product for improving user interaction by providing educational material via an integrated augmented reality game according to claim 8, wherein the educational material is in the form of a video, an article, a sound-clip, or a puzzle.

14. The computer program product for improving user interaction by providing educational material via an integrated augmented reality game according to claim 8, wherein the gamer device comprises: a smart phone, a virtual reality headset, a virtual reality ocular system, or a combination thereof.

15. A method for providing educational material via an integrated augmented reality game comprising:
receiving, from a gamer on a gamer device, a request to access an augmented reality gaming platform, wherein the augmented reality gaming platform comprises one or more educational augmented reality games;
requesting identification from the gamer via the gamer device;
determining whether the identification from the gamer is authentic;
gathering gamer profile data associated with the gamer, wherein the gamer profile data comprises at least one of a financial account associated with the gamer and gamer activity associated with one or more external systems;
providing the gamer access to the augmented reality gaming platform;
receiving an indication from the gamer device of a goal to complete at least one of the one or more educational augmented reality games;
recording one or more interactions between the gamer and the at least one of the one or more educational augmented reality games;
storing the one or more interactions to the gamer profile data;
determining that the gamer has completed the goal;
transmitting remuneration to the gamer, wherein the transmitted remuneration is stored to the gamer profile data for utilization by the gamer;
receiving a request to transfer at least a portion of the remuneration from the gamer profile data to at least one of the one or more external systems;
communicatively connecting a channel to the at least one of the one or more external systems, wherein the at least one external systems comprises a digital remuneration utilization marketplace;
transforming the portion of the remuneration into a format compatible for utilization within the digital remuneration utilization marketplace; and
transmitting the transformed remuneration to the at least one external system.

16. The method for providing educational material via an integrated augmented reality game according to claim 15, further comprising receiving an indication to redeem the remuneration for at least one of virtual content and physical content.

17. The method for providing educational material via an integrated augmented reality game according to claim 15, further comprising pushing a notification to the gamer device, based on the gamer profile data.

18. The method for providing educational material via an integrated augmented reality game according to claim 15, wherein the transformed gamer remuneration is recorded on a distributed ledger.

19. The method for providing educational material via an integrated augmented reality game according to claim 15, wherein the educational material is in the form of a video, an article, a sound-clip, or a puzzle.

20. The method for providing educational material via an integrated augmented reality game according to claim 15, wherein the gamer device comprises: a smart phone, a virtual reality headset, or a combination thereof.
